(19) United States
(12) Patent Application Publication
(10) Pub. No.: US 2007/0062277 A1
(43) Pub. Date: Mar. 22, 2007

(54) Fluid intake tracker

(76) Inventor: Lisa Patrice Miller, San Clemente, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 11/508,557

(22) Filed: Aug. 22, 2006

Related U.S. Application Data
(63) Continuation-in-part of application No. 10/621,598, filed on Jun. 3, 2004.

(30) Foreign Application Priority Data
Oct. 16, 2003 (CN) 200320100943.9
Oct. 16, 2003 (CN) 200320100942.4
Oct. 16, 2003 (CN) 200320100944.3
Oct. 16, 2003 (TW) 092218022
Oct. 16, 2003 (TW) 092218023
Oct. 16, 2003 (TW) 092218020
Oct. 16, 2003 (TW) 092218021

(51) Int. Cl. G01F 19/00

(52) U.S. Cl. 73/428; 73/426; 220/694

(57) ABSTRACT

A fluid intake tracking apparatus that is configured to reversibly couple with a water bottle, mug or other fluid container to keep track of the number of bottles that are consumed by the user during a selected period of time. In one embodiment, the indicator is an electronic device with a display, timer and alarm and powered by a solar cell. In another embodiment, the indicator is permanently mounted to a cup and includes a slidable post within a longitudinal slot and a parallel scale of numbers indicating the intake events.

### CROSS-REFERENCE TO RELATED APPLICATIONS

This application is a continuation-in-part of copending application Ser. No. 10/621,598, filed on Jun. 3, 2004, incorporated herein by reference in its entirety, and claims priority to Chinese Application 200320100943.9, with an effective date of Oct. 16, 2003; Chinese Application 200320100942.4, with an effective date of October 16, 2003; Chinese Application 200320100944.3, with an effective date of Oct. 16, 2003; Taiwan Application 092218022, with an effective date of Oct. 16, 2003; Taiwan Application 092218023, with an effective date of Oct. 16, 2003; Taiwan Application 218020with an effective date of Oct. 16, 2003; and Taiwan Application 092218021, with an effective date of Oct. 16, 2003, each of which is incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND OF THE INVENTION

1. Field of the Invention

This invention pertains generally to hydration schemes, and more particularly to a fluid intake tracker.

2. Description of Related Art

Proper hydration is essential to human health. The intake of sufficient volumes of water over the course of a day is particularly important for medical patients undergoing certain treatments that require the maintenance of threshold concentrations of medicine or treatments that cause dehydration. One difficulty encountered by individuals desiring to drink a set number of glasses of water in a day is tracking the number and volume of intake events over the course of the day. Often the consumption of the desired number of glasses of water is not achieved during the day because the individual does not accurately track the number of glasses and mistakenly believes that the intake is greater than it actually is. For most people, the lack of sufficient liquid consumption during the day is inadvertent and due to inattentiveness.

The medical community suggests that healthy people should consume a minimum of eight eight-ounce glasses of water per day. Proper hydration promotes optimal kidney and other organ and body functions. Deficiencies in fluid intake and hydration can also lead to dizziness and other transient effects. Many people, including medical care providers, can benefit from a physical reminder and monitor of fluid consumption.

### BRIEF SUMMARY OF THE INVENTION

The fluid intake tracker will help an individual to keep track of the recommended daily requirements of water or other fluids. The device is intended to remind individuals to drink a minimum of eight glasses of water or other fluids per day. The device can also allow parents to monitor how many glasses of soft drinks or other beverages that are consumed by a child. Likewise, a care provider can efficiently monitor the intake of liquid nutrition supplements and other fluids by a patient.

For many people it is difficult to remember how many glasses of water are consumed over the course of a day. The fluid intake tracker provides a running count of the number of glasses or volumes of liquid and acts as a constant reminder to meet the goal of eight glasses per day.

In one embodiment, the intake tracker is integrated into the side of a cup, sports bottle or other container capable of containing fluids. The tracker includes an indicator that can move within a slot in a panel. The panel has numbers 1-8 (or more) that are adjacent to the slot. The indicator is aligned with the number with each new glass of water placed in the container.

In another embodiment, a container with an integrated fluid intake tracker is a combination of two interlocking cups of different diameters, the inner cup sliding into the outer cup. The rim of the inserted inner cup had numbers on the side, displaying numbers 1 through 8 or 1 through 10, indicating which number of glasses that have been consumed. The outer cup displays an arrow to indicate which number of cups an individual has consumed. Both pieces would work together by circumferentially turning the inner cup independently from the outer cup, lining up the arrow to indicate the number.

In another embodiment, the intake tracker is mounted to a means for reversibly coupling the intake tracker with a container. In this embodiment, the intake tracker is mounted to an insulated sleeve and bottom that is configured to receive a water bottle or can. Similarly, a sleeve with a zipper, collar and handle is provided.

A further embodiment comprises a cylindrical clip, which will partially enclose a water bottle or can reversibly coupling the clip to the bottle.

Another embodiment includes a flexible strap with hook and loop fasteners at each end to allow the strap to be wrapped around different sized bottles and can be adjustable.

The fluid intake tracker may also use an electronic tracker with a digital display of the number of glasses of water that have been consumed. In one embodiment, the device has a chip contained in a housing with a digital display and buttons to set and reset the drink numbers and/or sizes. In another embodiment, the chip has a timing and alarm function that can be set to remind the user to drink a certain volume during the time period.

According to one aspect of the invention, a fluid intake tracking apparatus is provided that a body; an intake indicator mounted to the body; and means for reversibly coupling the body to a fluid container.

According to another aspect of the invention, a fluid intake tracker is provided that has a container with exterior and interior walls and a detachable plate attached to the exterior wall and an intake indicator coupled to the plate that has a programmable electronic device with a display, controls and a power source, wherein the display indicates a number representing the number of intake events upon actuation of said controls to a limit programmed by the user.

Another aspect of the invention is to provide a fluid intake tracker that has a timer and an audible alarm or a visual alarm indicating whether the user has consumed the fluid during the selected time period.

Another aspect of the invention is to provide a fluid intake tracker that can be readily transferable from one container to another that is easy to use an inexpensive to manufacture.

A still further aspect of the invention is to provide a fluid intake tracker that has a container with an exterior wall with a longitudinal slot; and an intake indicator including a post with a base disposed within the longitudinal slot configured to slide within said slot and a scale of numerals in parallel alignment to said longitudinal slot of said exterior wall, wherein the post is advanced along said longitudinal slot and positioned aside a numerals of the scale of numerals by a user to identifies the number of fluid intake events.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a side view of one embodiment of the fluid intake tracker according to the invention integrated within the wall of a cup container.

FIG. 2 is a side view of an insulated sleeve with a fluid intake tracker according to one embodiment of the present invention within the wall of the sleeve.

FIG. 3 is a zippered sleeve receptacle for a water bottle with a fluid intake tracker and handle.

FIG. 4 is a resilient clip with a fluid intake tracker according the invention.

FIG. 5 is a cross-sectional view of one manual embodiment of the fluid intake tracker taken along the line 5-5 of FIG. 4

FIG. 6 is a front view of a digital fluid intake tracker in a wrap around band with fasteners for an adjustable fit.

FIG. 7 is a top view of a solar powered embodiment of a digital fluid intake tracker according the present invention.

FIG. 8 is an alternative embodiment of a fluid intake tracker cup.

### DETAILED DESCRIPTION OF THE INVENTION

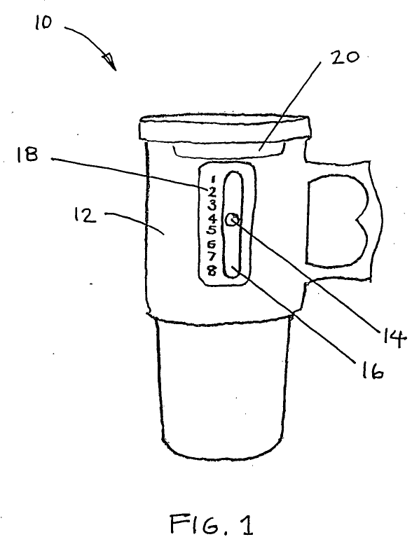

Referring more specifically to the drawings, for illustrative purposes the present invention is embodied in the apparatus generally shown in FIG. 1 through FIG. 8. It will be appreciated that the apparatus may vary as to configuration and as to details of the parts, and that the method may vary as to the specific steps and sequence, without departing from the basic concepts as disclosed herein.

Turning now to FIG. 1, one embodiment of the fluid intake tracker is shown integrated into a container such as a cup. Although a cup is shown to illustrate a container, it will be understood that a bottle, flask or other fluid receptacle with or without a lid may be used. In the embodiment shown in FIG. 1, the fluid intake tracker 10 is mounted to or integrated into the wall of the cup 12. In another embodiment, the tracker 10 may be a detachable plate. The intake tracker 10 has an indicator 14 that slides within a channel or slot 16. Intake numbers 18 are disposed along the length of the slot 16 to provide a visual indication of the number of intake events that take place with the user of the cup.

In use, the indicator 14 is positioned at the top of the slot 16 at a location next to the number one when the cup is filled with water or other fluid. The indicator 14 is advanced sequentially along the slot 16 to the next number in line each time the cup is filled with liquid for consumption. In another embodiment, (not shown) the slot 16 may have notches next to each of the numbers 18 to secure the location of the indicator to avoid involuntary movement of the indicator 14 due to impacts or other actions of the cup 12. It can also be seen that the container 12 with the embodiment of the fluid intake tracker 10 shown in FIG. 1, can be washed in a mechanical dish washing machine or by hand without damaging the fluid intake tracker.

The container 12 and fluid intake tracker 10 are preferably composed of inert plastic material that is durable and easy to maintain. However, the unit may also be made from aluminum or other metals as well as porcelain or a combination of materials. It is also preferred that the container 12 be capable of holding hot or cold liquids and may be insulated.

Optionally, the container 12 shown in FIG. 1 may have promotional indicia 20 printed on the outside wall of the container for company marketing, issue promotion or for personalization of the container. The indicia 20 may be a company name, an event name, a trademark or service mark, a slogan, political statements, humorous phrases, graphic elements, private labels, product names, personal names and the like. The promotional indicia 20 allow the container to be personalized to an individual or as a promotional item for a company for marketing purposes.

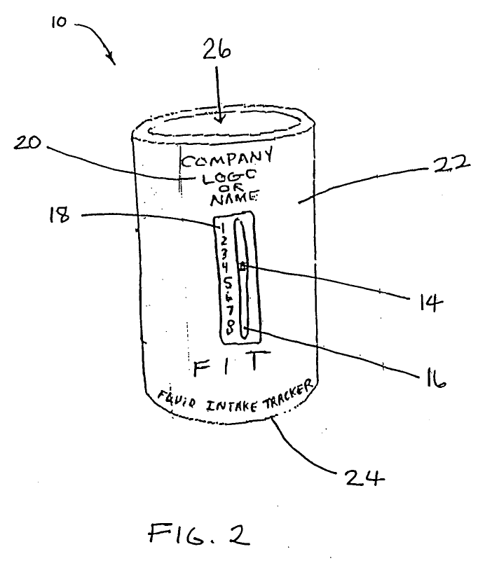

Turning now to FIG. 2, an alternative embodiment of the fluid intake tracker 10 is shown. In this embodiment, the fluid intake tracker 10 is integrated in to an insulated cylindrical sleeve 22 with an insulated bottom 24. The sleeve 22 is preferably manufactured from neoprene or an insulated foam material that provides insulation for maintaining the temperature of cold or hot liquids. A container such as a can or water bottle is inserted into the interior 26 of sleeve 22. The interior 26 of sleeve 22 may have a lining of cloth or other material that permits the smooth insertion and retraction of the water bottle, can or similar container during use. The sleeve may also be manufactured and specifically sized to receive 16 ounce or 32 ounce containers or may be resilient to receive many different can sizes.

The indicator 14 of the intake tracker 10 is advanced in slot 16 to the next consecutive number 18 when a new container is placed in the interior 26 of sleeve 22. In another embodiment, the plate with slot 16 and indicator post 14 is detachable.

The embodiment shown in FIG. 2 is particularly suited to tracking the intake of cold water or beverages where the cold or hot temperature of the fluid is to be maintained. For example, it is possible to track the intake of protein or supplemental nutrition drinks by a patient during the course of a day or several days. The fluid intake tracker 10 indicates the container number without reference to any other recordation scheme and it helpful when care is given over several shift changes. Likewise, a parent or childcare giver can monitor the consumption of juice, soft drinks or water by young children to limit or encourage fluid intake.

Sleeve 22 may also have a company name or logo or other promotional indicia 20 printed on the exterior of the sleeve. These indicia may serve an advertising function or may serve to personalize the sleeve 22 to the owner.

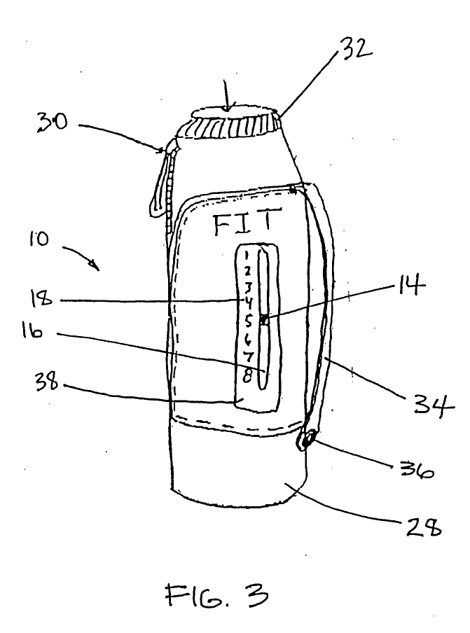

An alternative sleeve 28 is shown in FIG. 3. The sleeve 28 has a longitudinal zipper 30 that allows the opening of the sleeve to expand to receive the water bottle or can and then close. A resilient elastic collar 32 can envelop the top portion of water bottles that are tapered and restricts any movement of the bottle within the sleeve 28. An optional handle 34 is attached to the sleeve 28 to facilitate handling and transportation of the bottle and sleeve. The handle 34 may be adjustable with the use of a fastener 36 so that the sleeve will tightly engage the hand during use, which is particularly useful for users that are walking or jogging.

The sleeve 28 is preferably manufactured from nylon and may be insulated. The sleeve may also be made from neoprene or some other flexible insulating material. The sleeve 28 may also be sized to receive conventional bottles or cans of typical sizes or may be sized to receive all of the conventionally sized bottles.

The fluid intake tracker 10 is mounted to the side of the sleeve 28. In one embodiment, the fluid intake tracker 10 has a rigid plate 38 with an elongate slot 16 and numbers 18 indicating the number of volumes of liquid that were consumed.

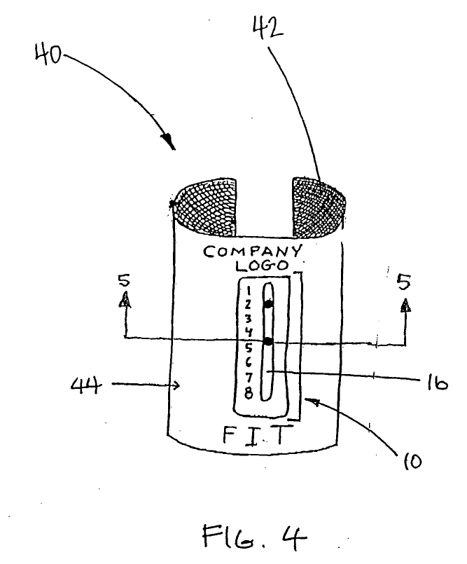

Referring now to FIG. 4, a clip embodiment of the fluid intake tracker 10 is shown. The clip 40 has a generally “C” shaped cross-section and preferably manufactured from flexible, resilient plastic. The cross-sectional area is configured to engage the sidewall of a water bottle, cup or other beverage container. In the embodiment shown, the interior of the clip has a fabric material 42 that assists in keeping the clip engaged with the side-wall of the bottle or can. The material 42 may also be made of tacky rubber. The material may also have an insulation layer of foam or neoprene so that the temperature of the liquid will be kept reasonably constant. The exterior of the clip 40 may optionally have an outer sheath of flexible fabric such as nylon (not shown) that is disposed over the outer surface 44 of the clip 40. Advertising, graphic elements or other promotional indicia may be printed on the sheath.

The clip 40 can be removed by flexing the opposing legs of the “C” shaped clip and removing bottle from the central bore of the clip 40. The fluid intake tracker 10 is integrated with or mounted to the sidewall 44 of clip 40. Indicator 14 slides along the longitudinal slot 16 to indicate the number of intake episodes.

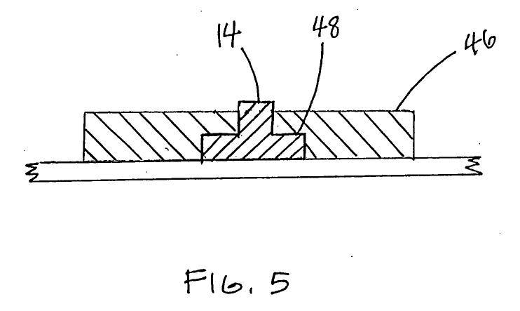

One embodiment of the manual fluid intake 10 is shown in a cross-sectional view in FIG. 5 taken along the lines 5-5 of FIG. 4. The indicator 14 slides within slot 16 and a groove 48 of outer plate 46. The groove 48 and slot 16 are preferably of sufficient length to allow indicator 14 to advance to at least eight stations corresponding to the numbers 18 on the surface of plate 46.

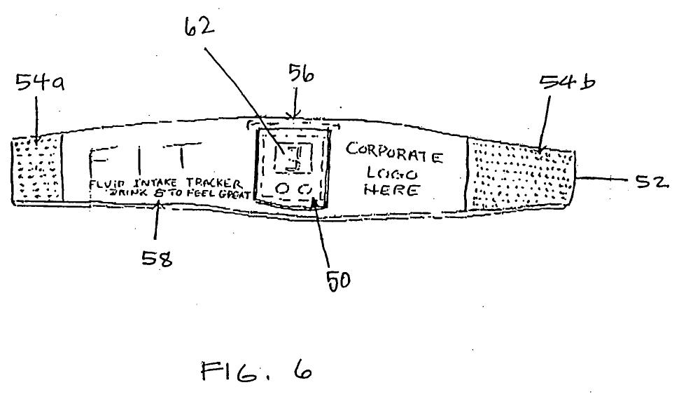

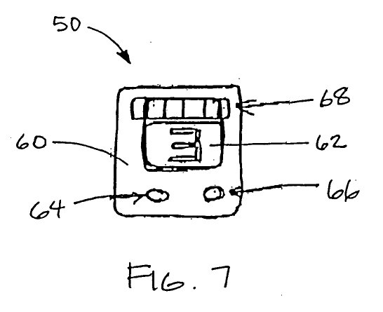

An electronic fluid intake tracker device 50 is shown in FIG. 6 and FIG. 7. In the embodiment shown in FIG. 6, a flexible elongate strap 52 with a fastener 54a and 54b at the ends of the strap. The strap 52 is preferably manufactured from a resilient material such as neoprene or foam backed fabric.

In use, the strap is wrapped around a container and secured by the fasteners. A hook and loop type fastener 54a and 54b is preferred so that the diameter or the strap 52 is adjustable to fit around many different sizes of bottles, cans or other containers.

Strap 52 has a transparent pocket 56 that is sized to receive and carry the digital fluid intake tracker 50. Although a transparent material for pocket 56 is preferred, the pocket 56 may be opaque with a window to allow the display of the digital fluid intake tracker 50 to be viewed from the exterior. Pocket 56 may also have a fastener or flap (not shown) to enclose the interior of the pocket 56 to keep the tracker 50 from falling out of the pocket.

Promotional indicia 58 may be printed on the surface of strap 52 to advertise a company or personalize the device.

Referring also to FIG. 7, the digital fluid tracker 50 is generally shown. The tracker 50 has a chip in a housing 60 with a display 62 that displays the number of containers or volumes of fluid that are consumed. The housing 60 can vary is size but is preferably approximately one inch square in the embodiment shown. The display 62 may be a liquid crystal or other suitable display to provide a visible number or time. A number reset button 64 will reset the intake count. A second button 66 will select and reset the ounces of fluid (8 oz., 16 oz. or 32 oz.).

In another embodiment, the fluid intake tracker 50 has a programmable alarm that allows the user to set at least eight time points during the day to create an audible reminder alarm for the user to evaluate their fluid intake. Such time points are typically evenly spaced throughout the day so that there is an even intake of fluid. This avoids the need for increasing the number of bottles consumed toward the end of the day to make up for lower consumption in the early part of the day.

Power for the digital fluid intake tracker can be provided by a battery or from a solar cell 68. A lithium coin cell battery is preferred to permit a relatively thin housing 60, if a battery alone is used.

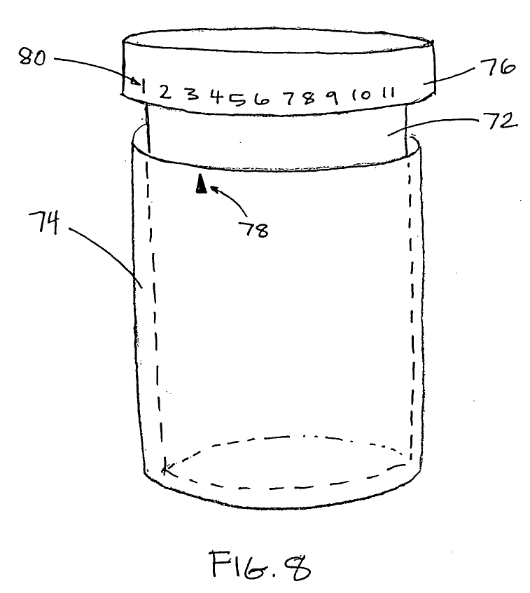

An alternative embodiment of the manual fluid intake tracker that is integrated into a cup or sports bottle is shown in FIG. 8. The intake tracker 70 is composed of an inner cup 72 and an outer cup 74 that interlock. The inner cup 72 has a smaller diameter than outer cup 74 and has a rim 76 that has a greater circumference than that of the inner cup 72. The inner cup 72 is placed in the outer cup 74 and the top rim of the outer cup fits in a groove in the rim 76 of the inner cup. The inner cup 72 can move or rotate with respect to the outer cup 74. Accordingly, an arrow 78 disposed on the outer surface of outer cup 74 can move relative to the numbers 80 on the rim 76 of the inner cup to indicate the number of intake volumes that have been consumed. The inner cup 72 and the outer cup 74 can be made of different materials such as a metal inner cup and a plastic outer cup.

It can be seen that the rotating fluid intake tracker cup will help an individual keep track of the recommended daily requirements of water or other fluids. The device will automatically provide the daily allowance of water or fluid intake based on the fluid ounces set into counter (example: 16 oz, 32 oz, etc.) The device could also keep track of how many glasses of water and/or other fluids an individual may want to monitor or consume (i.e. soft drinks, punch, coffee, etc.).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A fluid intake tracker, comprising:
a body;
an intake indicator mounted to said body; and
means for reversibly coupling the body to a fluid container.

2. A fluid intake tracker as recited in claim 1, wherein said body and said means for reversibly coupling the body to a fluid container comprises a flexible arcuate body with a generally “C” shaped cross section.

3. A fluid intake tracker as recited in claim 2, further comprising:
a lining of insulation disposed on an interior surface of said arcuate body.

4. A fluid intake tracker as recited in claim 1, wherein said means for reversibly coupling the body to a fluid container comprises a strap with a fastener.

5. A fluid intake tracker as recited in claim 4, wherein said fastener comprises a hook and loop type fastener.

6. A fluid intake tracker as recited in claim 1, wherein said means for reversibly coupling the body to a fluid container comprises an insulated sleeve.

7. A fluid intake tracker as recited in claim 1, wherein said means for reversibly coupling the body to a fluid container comprises an insulated sleeve with a zipper and a collar mounted circumferentially around a rim of said sleeve.

8. A fluid intake tracker as recited in claim 7, further comprising a handle attached to said insulated sleeve.

9. A fluid intake tracker as recited in claim 1, wherein said intake indicator comprises an electronic device with a display mounted to said body, said electronic device configured to numerically display intake events.

10. A fluid intake tracker as recited in claim 9, further comprising:
an alarm configured to activate at time intervals set by the user.

11. A fluid intake tracker as recited in claim 9, said electronic device further comprising:
a housing enclosing said electronic device configured to attach and detach from said body and be transferable from one body to another.

12. A fluid intake tracker as recited in claim 9, said electronic device further comprising:
a solar cell mounted to said housing providing power to said electronic device.

13. A fluid intake tracker as recited in claim 1, further comprising:
promotional indicia applied to said body of said fluid intake tracker.

14. A fluid intake tracker, comprising:
a container having exterior and interior walls, said exterior wall having a detachable plate; and
an intake indicator coupled to said plate, said indicator comprising:
a programmable electronic device with a display, controls and a power source,
wherein the display indicates a number representing the number of intake events upon actuation of said controls to a limit programmed by the user.

15. A fluid intake tracker as recited in claim 14, wherein said intake indicator further comprises:
a timer; and
an alarm,
wherein said alarm activates at time intervals set by the user to remind the user to consume a certain volume of fluid during a time period.

16. A fluid intake tracker as recited in claim 15, wherein said alarm is a flashing light.

17. A fluid intake tracker as recited in claim 14, wherein said power source comprises a solar cell.

18. A fluid intake tracker as recited in claim 14, further comprising:
promotional indicia applied to said body of said fluid intake tracker.

19. A fluid intake tracker, comprising:
a container having exterior and interior walls, said exterior wall having a longitudinal slot; and
an intake indicator comprising:
a post with a base disposed within said longitudinal slot configured to slide within said slot; and
a scale of numerals in parallel alignment to said longitudinal slot of said exterior wall,
wherein said post is advanced along said longitudinal slot and positioned aside a numerals of the scale of numerals by a user to identifies the number of fluid intake events.

20. A fluid intake tracker as recited in claim 19, further comprising:
promotional indicia applied to said exterior wall of said container of the fluid intake tracker.
